(19) United States
(12) Patent Application Publication
(10) Pub. No.: US 2020/0004298 A1
(43) Pub. Date: Jan. 2, 2020

(54) ELECTRONIC DEVICE AND TRANSFORMING METHOD THEREOF

(71) Applicant: Lenovo (Beijing) Co., Ltd., Beijing (CN)

(72) Inventors: Youze LI, Beijing (CN); Jia ZHANG, Beijing (CN); Yiping FENG, Beijing (CN); Yong TAN, Beijing (CN)

(21) Appl. No.: 16/458,753

(22) Filed: Jul. 1, 2019

(30) Foreign Application Priority Data
Jun. 29, 2018 (CN) 201810701016.3

(51) Int. Cl. G06F 1/16; H04M 1/02

(52) U.S. Cl. CPC G06F 1/1652; H04M 1/0268; G06F 1/162; G06F 1/1601

(57) ABSTRACT

An electronic device transforming method and an electronic device are provided. The electronic device transforming method comprises transforming a main body of an electronic device under an external force, wherein in response to transforming the main body of the electronic device, an auxiliary body of the electronic device is transformed along with the main body of the electronic device. A transformation direction of the main body is opposite to a transformation direction of the auxiliary body.

### CROSS-REFERENCES TO RELATED APPLICATIONS

This application claims the priority of Chinese patent application No. 201810701016.3, filed on Jun. 29, 2018, the entire content of all of which is incorporated herein by reference.

### FIELD OF THE DISCLOSURE

The present disclosure relates to the field of connection technologies and, more particularly, relates to an electronic device and a transforming method thereof.

### BACKGROUND

Electronic devices are commonly used devices which often include a main body and an auxiliary body. However, because the main body of existing electronic devices cannot be transformed, the applications of existing electronic devices are rather limited.

### BRIEF SUMMARY OF THE DISCLOSURE

One aspect of the present disclosure provides an electronic device transforming method. The electronic device transforming method comprises: transforming a main body of an electronic device under an external force, wherein in response to transforming the main body of the electronic device, an auxiliary body of the electronic device is transformed along with the main body of the electronic device. A transformation direction of the main body is opposite to a transformation direction of the auxiliary body.

Another aspect of the present disclosure provides an electronic device. The electronic device comprises a main body, wherein the main body is transformed under an external force; and an auxiliary body, wherein in response to transforming the main body of the electronic device, the auxiliary body is transformed along with the main body. A transformation direction of the main body is opposite to a transformation direction of the auxiliary body.

Other aspects of the present disclosure may be understood by those skilled in the art in light of the description, the claims, and the drawings of the present disclosure.

### BRIEF DESCRIPTION OF THE DRAWINGS

To more clearly illustrate technical solutions of embodiments or in the prior art, accompany drawings which need to be used in the description of the embodiments or the prior art will be simply introduced. Obviously, the accompany drawings in the following description are merely some embodiments, and for those of ordinary skill in the art, other embodiments may further be obtained according to these accompany drawings without contributing any creative work.

FIG. 1 illustrates a schematic view of an exemplary electronic device consistent with the disclosed embodiments;

FIG. 2 illustrates a schematic view of another exemplary electronic device consistent with the disclosed embodiments;

FIG. 3 illustrates a schematic view of another exemplary electronic device consistent with the disclosed embodiments; and

FIG. 4 illustrates a flow chart of an exemplary electronic device transforming method consistent with the disclosed embodiments.

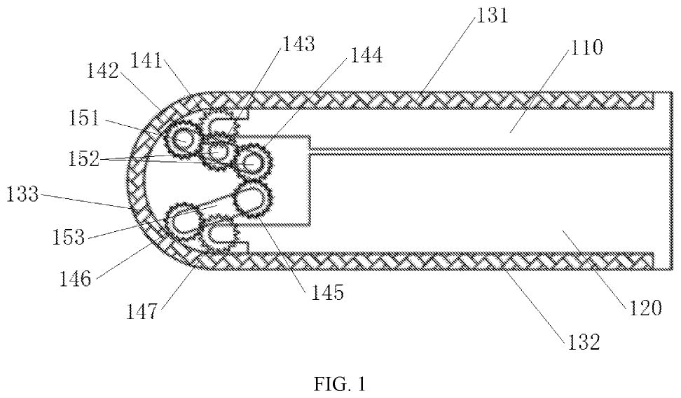

In FIGS. 1-4: 110, a first body; 120, a second body; 131, a first planar portion; 132, a second planar portion; 133, a bent portion; 141, a first transmission; 142, a second transmission; 143, a third transmission; 144, a fourth transmission; 145, a fifth transmission; 146, a sixth transmission; 147, a seventh transmission; 151, a first fixed shaft; 152, a first rotating shaft assembly; 153, a connector; 154, a second fixed shaft; 155, a second rotating shaft; 156, a third fixed shaft; 157, a fourth fixed shaft; 161, a first fastener; 162, a second fastener; 163, a third fastener; and 164, a fourth fastener.

### DETAILED DESCRIPTION

Reference will now be made in detail to example of an embodiments of the disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

In the description of disclosed embodiments, it should be noted that, unless otherwise stated and limited, the term “connected” should be understood broadly. For example, it may be an electrical connection or a communication between two components, which may be directly connected or indirectly connected through an intermediate medium. The specific meaning of the above terms may be understood by a person of ordinary skill in the art according to the specific situation.

It should be noted that, in the embodiments of the present disclosure, the terms “first”, “second”, “third” and the like are merely intended to distinguish between similar objects rather than describe specific orders. It may be understood that, the data termed in such a way is interchangeable in proper circumstances, and therefore the embodiments of the present disclosure described herein may be implemented in orders other than the order illustrated or described herein.

The electronic device described in the embodiment of the present application will be described in detail below with reference to FIGS. 1-3. As shown in FIGS. 1-3, the electronic device may include: a main body and an auxiliary body. The main body may be transformed under an external force, and during the transformation of the main body of the electronic device, the auxiliary body may be transformed along with the main body. The transformation direction of the main body may be opposite to the transformation direction of the auxiliary body.

The present disclosure does not limit the specific structure of the electronic devices. For example, the electronic device may be a computer, a mobile phone, or an e-book. Further, the main body of the electronic device may be a main functional component of the electronic device, and the specific structure thereof is not limited by the present disclosure, as long as the main body of the electronic device is able to be transformed under an external force.

In one embodiment, the main body of the electronic device may include a first body 110, a second body 120, and a transforming member connecting the first body 110 and the second body 120. Under an external force, the first body 110 may be rotated relative to the second body 120 with respect to an axis between the first body 110 and the second body 120, such that the transforming member may be transformed. The transforming member may be transformed based on a structure or a deformation. For example, the transforming member may include N sleeves, where N is an integer equal to or larger than 2. An outer diameter of the n-th sleeve may be smaller than an inner diameter of the (n+1)-th sleeve. The n-th sleeve may be completely located in the (n+1)-th sleeve and may rotate in the radial direction of the (n+1)-th sleeve in the (n+1)-th sleeve, where n is an integer equal to or larger than 1 and smaller than N. For another example, the transforming member may include a spring.

The present disclosure does not limit the shape and structure of the first body 110 and the second body 120, which may be determined according to various application scenarios. Further, the first body 110 and the second body 120 are purposely generic, each of which is not specifically defined as a certain part of the electronic device. Here, the shape of the second body 120 and the shape of the first body 110 may be the same or different.

In the disclosed embodiments, the auxiliary body of the electronic device may be an auxiliary component of the electronic device, and the specific structure thereof is not limited by the present disclosure, as long as the auxiliary body is capable of being transformed along with the transformation of the main body, and the transformation direction of the main body is opposite to the transformation direction of the auxiliary body. In one embedment, the main body of the electronic device may include the first body 110, the second body 120, and the transforming member connecting the first body 110 and the second body 120. The auxiliary body of the electronic device may include a connecting device which couples the first body 110 to the second body 120. The first body 110 may be rotated, via the external force, relative to the second body 120 with respect to an axis between the first body 110 and the second body 120 and, accordingly, the transforming member may be transformed.

During the transformation of the transforming member, the connecting device may be transformed along with the transforming member, and the transforming direction of the connecting device may be opposite to the transforming direction of the transforming member. The connecting device may be transformed based on a structure or a deformation. For example, the connecting device may include a chain. For another example, the connecting device may include a flexible member. In one embodiment, the flexible member may be composed of a flexible metal or a flexible polymer material. The flexible member may be transformed under an external force, and maintain the transformation in response to the removal of the external force. In summary, the flexible member may be composed of a material having a transformability and a weak automatic transformation recoverability. The weak automatic transformation recoverability may be understood as: the flexible member may not save potential energy due to the transformation, such that the flexible member may not automatically recover to the original form.

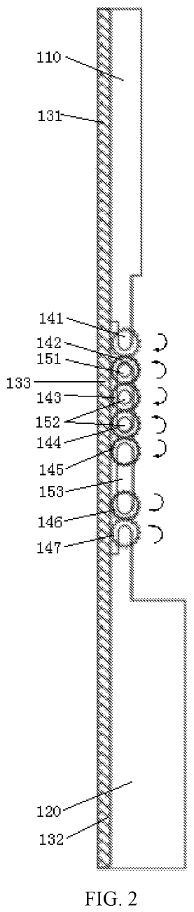

In one embodiment, as shown in FIGS. 1-2, the main body of the electronic device may include a first body 110, a second body 120, and a flexible screen. The auxiliary body of the electronic device may include a connecting device. The first body 110 may be rotatably coupled to the second body 120 through the connecting device. The flexible screen may be fixedly disposed on the first body 110 and the second body 120. Under an external force, the first body 110 may be rotated relative to the second body 120 within a predetermined range, with respect to an axis between the first body 110 and the second body 120 and, accordingly, the flexible screen may be transformed. During the transformation of the flexible member, the connecting device may be transformed along with the flexible screen, and the transformation direction of the connecting device may be opposite to the transformation direction of the flexible screen.

In one embodiment, as shown in FIGS. 1-2, the first body 110 and the second body 120 each may have a shape similar to rectangular shape, which is for illustrative purposes and is not intended to limit the scope of the present disclosure. In addition, in FIGS. 1-2, the shape of the second body 120 may be the same as the shape of the first body 110, such that through the connecting device, the second body 120 and the first body 110 may be rotationally fitted with each other without any displacement.

In the disclosed embodiments, the predetermined range may be determined according to various application scenarios. For example, the predetermined range may be 0 to 360 degrees, 0 to 190 degrees, or 0 to 180 degrees. After rotating the first body 110 relative to the second body 120 from 0 to 180 degrees by the connecting device, the first body 110 and the second body 120 may be flattened to the same plane from being relatively fitted with each other. That is, before rotating the first body 110, the first body 110 and the second body 120 may be relatively fitted with each other, and after rotating the first body 110 relative to the second body 120 by 180 degrees, the first body 110 and the second body 120 may be flattened to the same plane.

Further, the shape and structure of the flexible screen are not limited by the present disclosure, as long as the flexible screen is fixedly disposed on the first body 110 and the second body 120, and under an external force, the first body 110 is able to rotate relative to the second body 120 by the connecting device within a predetermined range, with respect to an axis between the first body 110 and the second body 120, such that the flexible screen would be transformed. An exemplary flexible screen is illustrated below.

As shown in FIGS. 1-2, the flexible screen may include a first planar portion 131, a second planar portion 132 and a bent portion 133. The first planar portion 131 may be disposed on an outer side surface of the first body 110, where the outer side surface of the first body 110 rotates relative to the second body 120. The second planar portion 132 may be disposed on an outer side surface of the second body 120, where the outer side surface of the second body 120 rotates relative to the first body 110. The bent portion 133 may couple the first planar portion 131 to the second planar portion 132, and the bent portion 133 may be abutted against the connecting device. Under the external force, the first body 110 may be rotated relative to the second body 120 via the connecting device. Along with the first body 110, the first planar portion 131 may be rotated relative to the second planar portion 132 via the bent portion 133, and the bent portion 133 may be transformed.

The area of the first planar portion 131 is not limited by the present disclosure, as long as the first planar portion 131 is disposed on the outer side surface of the first body 110, where the outer side surface of the first body 110 rotates relative to the second body 120. For illustrative purposes, FIG. 1 shows the first planar portion 131 partially covers the outer side surface of the first body 110, where the outer side surface of the first body 110 rotates relative to the second body 120, and FIG. 2 shows that the first planar portion 131 fully covers the outer side surface of the first body 110, where the outer side surface of the first body 110 rotates relative to the second body 120.

The present disclosure does not limit the specific implementation manner of fixedly disposing the first planar portion 131 on the first body 110. In certain embodiments, the first flat portion 131 may be fixedly disposed on the first body 110 by adhesive, or by a clamping structure.

The present disclosure does not limit the area of the second planar portion 132, as long as the second planar portion 132 is disposed on the outer side surface of the second body 120, where the outer side surface of the second body 120 rotates relative to the first body 110. For illustrative purposes, FIG. 1 shows the second planar portion 132 covers an outer side surface of a portion of the second body 120, where the outer side surface of the second body 120 rotates relative to the first body 110, and FIG. 2 shows that the second planar portion 132 fully covers the outer side surface of the second body 120, where the outer side surface of the second body 120 rotates relative to the first body 110.

The present disclosure does not limit the specific implementation manner of fixedly disposing the second planar portion 132 on the second body 120. In one embodiment, the first flat portion 131 may be fixedly disposed on the second body 120 by adhesive, or by a clamping structure.

In one embodiment, the second planar portion 132 may have a shape same as the first planar portion 131, in another embodiment, the second planar portion 132 may have a shape different from the first planar portion 131. For illustrative purposes, FIGS. 1-2 show that the second body 120 may have the same shape as the first body 110, and the second planar portion 132 may have a shape different from the first planar portion 131. After the second body 120 and the first body 110 is rotatably fitted to each other without any displacement via the connecting device, the second planar portion 132 and the first planar portion 131 may form a symmetrical display structure, thereby facilitating the use of a small display screen on both sides of the electronic device.

The flexible screen may include the first planar portion 131, the second planar portion 132, and the bent portion 133. Under the external force, the first body 110 may be rotated relative to the second body 120 via the connecting device, and along with the first body 110, the first planar portion 131 may be rotated relative to the second planar portion 132 via the bent portion 133, and the bent portion 133 may be transformed. During the transformation of the bent portion 133, the connecting device may be transformed along with the bent portion 133, and the transformation direction of the connecting device may be opposite to the transformation direction of the bent portion 133.

The present disclosure does not limit the specific states of the transformation process of the connecting device and the bent portion 133, and those skilled in the art may determine the specific states of the transformation process of the connecting device and the bent portion 133 according to various application scenarios. In the following, an exemplary transformation process of the connecting device and the bent portion 133 is explained.

Under an external force, the first body 110 may be rotated relative to the second body 120 in a first direction via the connecting device. The first body 110 may be rotated relative to the second body 120 to a first angle. In response to rotating the first body 110 relative to the second body 120 to the first angle, the connecting device may be in a straightened state, the first body 110 and the second body 120 may be apart from each other by a first distance. Along with the first body 110, the first planar portion 131 may be rotated relative to the second planar portion 132 to a third angle, and the connecting device in the straightened state may support the bent portion 133 to enable the bent portion 133 to be in an unfolded state.

In response to rotating the first body 110 relative to the second body 120 to a second angle from the first angle, the connecting device may be gradually folded in a direction far away from the bent portion 133, the first body 110 may be moved relative to the second body 120 in a direction close to the second body 120, and the distance between the first body 110 and the second body 120 may be gradually decreased to a second distance. The connecting device may be in a folded state. Along with the first body 110, the first planar portion 131 may be rotated relative to the second planar portion 132 to a fourth angle from the third angle, the bent portion 133 may be gradually bent in a direction away from the connecting device, and the connecting device in the folded state may support the bent portion 133 to enable the bent portion 133 to be in a bent state.

Under the external force, the first body 110 may be rotated relative to the second body 120 by the connecting device in the second direction. The first body 110 may be rotated relative to the second body 120 to the second angle. In response to rotating the first body 110 relative to the second body 120 to the second angle, the connecting device may be in the folded state, and the first body 110 and the second body 120 may be separated from each other by a second distance. Along with the first body 110, the first planar portion 131 may be rotated relative to the second planar portion 132 to the fourth angle, and the connecting device in the folded state may support the bent portion 133 to enable the bent portion 133 to be in the bent state.

In response to rotating the first body 110 relative to the second body 120 from the second angle to the first angle, the connecting device may be gradually unfolded in a direction close to the bent portion 133, the first body 110 may be moved relative to the second body 120 in a direction away from the second body 120, the distance between the first body 110 and the second body 120 may be gradually increased to the first distance, and the connecting device may be in the straightened state. The first planar portion 131 may be rotated relative to the second planar portion 132 from the fourth angle to the third angle, and the bent portion 133 may be gradually unfolded in a direction close to the connecting device. The connecting device in the straightened state may support the bent portion 133 to enable the bent portion 133 to be in the unfolded state. The first direction may be opposite to the second direction are opposite.

In the disclosed embodiments, through configuring the connecting device to be in the straightened state, the connecting device may support the bent portion 133 to enable the bent portion 133 to be in the unfolded state, which may effectively prevent wrinkles/unflatteness on the bent portion 133. On the other hand, through configuring the connecting device to be in the folded state, the connecting device may support the bent portion 133 to enable the bent portion 133 to be in the folded state, which may effectively prevent the bent portion 133 from being damaged by the connecting device when the bent portion 133 is being bent.

In the disclosed embodiments, it is relatively speaking that the connecting device is in a straightened state and the connecting device is in a folded state, as long as the connecting device in the straightened state has a length greater than the connecting device in the folded state. The straightened state and the folded state of the connecting device may be determined according to various application scenarios. In addition, it is relatively speaking that the bent portion 133 is in the unfolded state and the bent portion 133 is in the bent state, as long as the angle between the first planar portion 131 and the second planar portion 132 where the bent portion 133 is in the unfolded state is greater than the angle between the first planar portion 131 and the second planar portion 132 where the bent portion 133 is in the bent state, and the bent portion 133 has no wrinkles when the bent portion 133 is in the unfolded state.

The first angle may be determined according to various application scenarios, as long as after the first body 110 is rotated relative to the second body 120 to the first angle, the connecting device is in the straightened state. For example, the first angle may range from 175 degrees to 185 degrees. Here, the rotation of the first body 110 relative to the second body 120 to the first angle means that, the first body 110 may be rotated relative to the second body 120 until an angle formed between the first body 110 and the second body 120 is the first angle.

Further, the first distance may be the distance between the first body 110 and the second body 120 when the connecting device is in the straightened state, and the first distance may increase along with the length of the connecting device in the straightened state. That is, the greater the length of the connecting device in the straightened state, the larger the first distance. The third angle may correspond to the first angle. The rotation of the first planar portion 131 relative to the second planar portion 132 to the third angle along with the first body 110 means that: along with the first body 110, the first planar portion 131 may be rotated relative to the first body 110 until an angle formed between the first planar portion 131 and the second planar portion 132 is the third angle. The third angle may be greater than or equal to the first angle.

For illustrative purposes, FIG. 2 shows that the first angle is 180 degrees and the third angle is 180 degrees, where the first body 110 and the second body 120 may be located in the same plane, and the first planar portion 131 and the second planar portion 132 may be located in the same plane. The connecting device in the straightened state may support the bent portion 133 to enable the bent portion 133 to be in the unfolded state, such that the flexible screen may be in a fully unfolded state and located in one plane to form a flat, non-pleated large screen and, accordingly, a large display screen may be realized.

The second angle may be determined according to various application scenarios, as long as after the first body 110 is rotated relative to the second body 120 to the second angle, the connecting device is in the folded state. For example, the second angle may range from 0 degrees to 10 degrees. Here, the rotation of the first body 110 relative to the second body 120 to the second angle means that, the first body 110 may be rotated relative to the second body 120 until an angle formed between the first body 110 and the second body 120 is the second angle.

Further, the second distance may be the distance between the first body 110 and the second body 120 when the connecting device is in the folded state, and the second distance may decrease along with the length of the connecting device in the folded state. That is, the shorter the length of the connecting device in the folded state, the smaller the second distance. The fourth angle may correspond to the second angle. The rotation of the first planar portion 131 relative to the second planar portion 132 to the fourth angle along with the first body 110 means that: along with the first body 110, the first planar portion 131 may be rotated relative to the first body 110 until an angle formed between the first planar portion 131 and the second planar portion 132 is the fourth angle. The fourth angle may be greater than or equal to the second angle.

For illustrative purposes, FIG. 1 shows that the second angle is 0 degree and the fourth angle is 0 degree, where the first body 110 may be fitted with the second body 120, and the first planar portion 131 may be parallel to the second planar portion 132. The connecting device in the folded state may support the bent portion 133 to enable the bent portion 133 to be in the bent state, such that the flexible screen may be folded to the outside of the first body 110 and the second body 120, and two small symmetrical display screens may be formed to facilitate the carry and storage of the flexible screen.

In the disclosed embodiments, the first direction is an A direction as shown in FIG. 2, and the second direction is a B direction as shown in FIG. 2.

The specific states of the transformation process of the connecting device and the specific states of the transformation process of the bent portion 133 will be described in detail below based on an exemplary connecting device.

In one embodiment, as shown in FIGS. 1-2, the connecting device may include a first transmission 141, a second transmission 142, a third transmission 143, a fourth transmission 144, a fifth transmission 145, a sixth transmission 146, a seventh transmission 147, a first fixed shaft 151, a first rotating shaft assembly 152, a connector 153, a second fixed shaft 154, and a second rotating shaft 155.

In particular, the first transmission 141may be fixedly coupled to the first body 110. The first fixed shaft 151 may be provided with the second transmission 142 which is a rotatable. The second transmission 142 may be cooperatively coupled to or mating connected to the first transmission 141. The first rotating shaft assembly 152 may include at least two first rotating shafts. The at least two first rotating shafts may include one first rotating shaft that abuts the first fixed shaft 151 and another first rotating shaft that abuts the second rotating shaft 155. The first rotating shaft that abuts the first fixed shaft 151 may have at least one end provided with the third transmission 143 which is rotatable, and the third transmission 143 may be cooperatively coupled to the second transmission 142. The first rotating shaft that abuts the second rotating shaft 155 may have at least one end provided with the fourth transmission 144 which is rotatable, and the fourth transmission 144 may be cooperatively coupled to the third transmission 143.

The seventh transmission 147 may be fixedly coupled to the second body 120. The second fixed shaft 154 may be fixedly disposed with the sixth transmission 146, and the sixth transmission 146 may be cooperatively coupled to the seventh transmission 147. The connector 153 may be hinged to the second fixed shaft 154. The second rotating shaft 155 may be fixedly coupled to the connector 153, and may be fixedly disposed with the fifth transmission 145. The fifth transmission 145 may be cooperatively coupled to the fourth transmission 144.

Under the external force, the first body 110 may be rotated relative to the second body 120 in the first direction via the first transmission 141, the second transmission 142, the third transmission 143, the fourth transmission 144, the fifth transmission 145, the sixth transmission 146, and the seventh transmission 147. In response to rotating the first body 110 relative to the second body 120 to the first angle, the first transmission 141to the seventh transmission 147 may be all in the straightened state. The first body 110 and the second body 120 may be apart by the first distance. Along with the first body 110, the first planar portion 131 may be rotated relative to the second planar portion 132 to the third angle. The first transmission 141, the second transmission 142, the third transmission 143, the fourth transmission 144, the fifth transmission 145, the sixth transmission 146, and the seventh transmission 147 in the straightened state may support the bent portion 133 to enable the bent portion 133 to be unfolded state.

In response to rotating the first body 110 relative to the second body 120 from the first angle to the second angle, the first transmission 141 may be rotated in the first direction along with the first body 110, and the first transmission 141 may be gradually moved in a direction away from the bent portion 133. The second transmission 142 may be rotated in the second direction along with the first transmission 141, the third transmission 143 may be rotated in the first direction along with the second transmission 142, and the fourth transmission 144 may be rotated in the second direction along with the third transmission 143. The fifth transmission 145 may be rotated in the first direction along with the fourth transmission 144 and rotated around the second rotating shaft 155 via the connector 153. The fifth transmission 145 and the fourth transmission 144 may be gradually moved in a direction away from the bent portion 133. Along with the fourth transmission 144, the third transmission 143 maybe gradually moved in a direction away from the bent portion 133. The seventh transmission 147 may be rotated along the second direction along with the second body 120, and the seventh transmission 147 may be gradually moved in a direction far away from the bent portion 133. The first body 110 may be moved relative to the second body 120 in a direction close to the second body 120, and the distance between the first body 110 and the second body 120 may be gradually reduced to the second distance. The first transmission 141 to the seventh transmission 147 may be in the folded state. The bent portion 133 may be gradually bent in a direction away from the second transmission 142. The second transmission 142 and the sixth transmission 146 in the folded state may support the bent portion 133 to enable the bent portion 133 to be in the bent state.

Under the external force, the first body 110 may be rotated relative to the second body 120 in the second direction through the first transmission 141, the second transmission 142, the third transmission 143, the fourth transmission 144, the fifth transmission 145, the sixth transmission 146, and the seventh transmission 147. In response to rotating the first body 110 relative to the second body 120 to the second angle, the first transmission 141 to the seventh transmission 147 may be in the folded state, and the first body 110 and the second body 120 may be apart by the second distance. Along with the first body 110, the first planar portion 131 may rotated relative to the second planar portion 132 to the fourth angle. The second transmission 142 and the sixth transmission 146 in the folded state may support the bent portion 133 to enable the bent portion 133 to be in the bent state.

In response to rotating the first body 110 relative to the second body 120 to the first angle from the second angle, the first transmission 141 may be rotated in the second direction along with the first body 110, and the first transmission 141 may be gradually moved in a direction close to the bent portion 133. The second transmission 142 may be rotated in the first direction along with the first transmission 141, the third transmission 143 may be rotated in the second direction along with the second transmission 142, and the fourth transmission 144 may be rotated in the first direction along with the third transmission 143. The fifth transmission 145 may be rotated in the second direction along with the fourth transmission 144 and rotated around the second rotating shaft 155 via the connector 153. The fifth transmission 145 and the fourth transmission 144 may be gradually moved in a direction close to the bent portion 133. Along with the fourth transmission 144, the third transmission 143 may gradually move in a direction close to the bent portion 133. The seventh transmission 147 may be rotated along the first direction along with the second body 120 and gradually moved in a direction close to the bent portion 133. The first body 110 may be moved relative to the second body 120 in a direction far away from the second body 120, and the distance between the first body 110 and the second body 120 may be gradually increased to the first distance. The first transmission 141 to the seventh transmission 147 may be in the straightened state. Along with the first body 110, the first planar portion 131 may be rotated relative to the second planar portion 132 from the fourth angle to the third angle, and the bent portion 133 may be gradually unfolded in a direction close to the second transmission 142. The first transmission 141, the second transmission 142, the third transmission 143, the fourth transmission 144, the fifth transmission 145, the sixth transmission 146 and the seventh transmission 147 in the straightened state may support the bent portion 133 to enable the bent portion 133 to be in the unfolded state.

In the disclosed connecting device, “cooperatively coupled to” or “mating connected to” may refer as two transmissions are cooperated to realize a connection for transmitting the rotational movement, and the two transmissions are rotated in opposite directions. For example, the cooperative coupling may be a connection in which the two gears transmit the rotational movement by engaging, or a connection in which the two ratchets transmit the rotational movement by engaging.

During the operation of the connecting device, the first transmission 141, the fifth transmission 145, the sixth transmission 146, and the seventh transmission 147 may be fixed to the shaft without rotating relative to the axis. The second transmission 142, the third transmission 143 and the fourth transmission 144 may be rotatably sleeved on the shaft, and rotatable relative to the axis. As shown in FIG. 2, in response to an external force applied to the electronic device, the first body 110 may be rotated relative to the second body 120 in the first direction A, and the first body 110 may drive the first transmission 141 to rotate in the first direction A. The second transmission 142 may be cooperatively coupled to the first transmission 141 to achieve a rotation on the first fixed shaft 151 in the second direction B. The third transmission 143 may be cooperatively coupled to the second transmission 142 to achieve a rotation in the first direction A, and the fourth transmission 144 may be cooperatively coupled to the third transmission 143 to achieve a rotation the second direction B. The fifth transmission 145 may be cooperatively coupled to the fourth transmission 144 to achieve a rotation in the first direction A. Meanwhile, because the fifth transmission 145 is fixed on the second rotating shaft 155, the fifth transmission 145 may drive the second rotating shaft 155 to rotate in the first direction A around the first fixed shaft 151 via the connector 153, thereby enabling the fifth transmission 145, the fourth transmission 144, and the third transmission 143 to move away from the bent portion 133. Meanwhile, the second body 120 may drive the seventh transmission 147 to rotate in the second direction B, and the sixth transmission 146 may be cooperatively coupled to the seventh transmission 147 to achieve a rotation on the second fixed shaft 154 in the first direction A, such that the electronic device may be folded.

It should be understood that, during the rotation of the first body 110 relative to the second body 120, the position of the first fixed shaft 151 and the position of the second fixed shaft 154 may be relatively fixed. Thus, the position of the second transmission 142 fixed to the first fixed shaft 151 and the position of the sixth transmission 146 fixed to the second fixed shaft 154 may be relatively fixed. Here “relatively fixed” refers as during the rotation of the first body 110 relative to the second body 120, the first fixed shaft 151 and the second fixed shaft 154 may be moved only in a direction to bring the first body 110 and the second body 120 closer to or away from each other, instead of being moved in a direction away from or close to the bent portion 133.

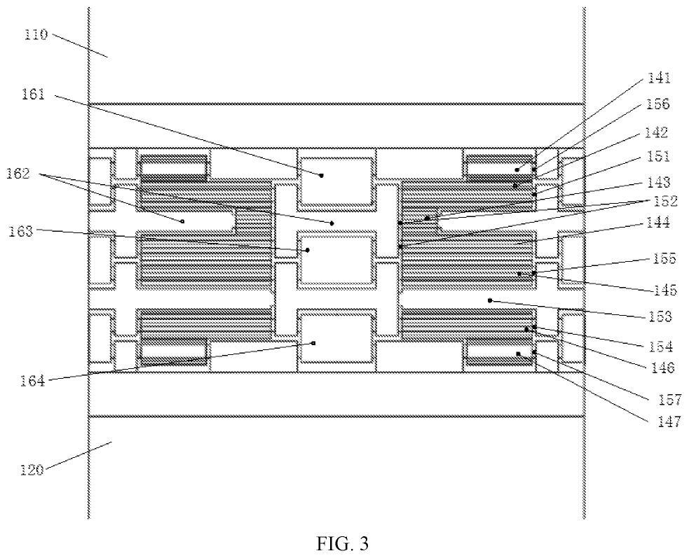

In the disclosed embodiments, the number of the connecting devices provided between the first body 110 and the second body 120 is not limited by the present disclosure. For illustrative purposes, FIG. 3 shows that the number of connecting devices is two. The first angle, the second angle, the third angle, the fourth angle, the first distance and the second distance have been described above, and details are not described herein again. The first transmission 141 may be directly fixed to the first body 110, or may be fixed to the first body 110 by other structures. For illustrative purposes, FIG. 3 shows a third fixed shaft 156 may be fixed to the first body 110, and the first transmission 141 may be fixed to the third fixed shaft 156. The seventh transmission 147 may be directly fixed to the second body 120, or may be fixed to the second body 120 by other structures. For illustrative purposes, FIG. 3 shows a fourth fixed shaft 157 may be fixed to the second body 120, and the seventh transmission 147 may be fixed to the fourth fixed shaft 157.

In the disclosed embodiments, the specific structure of the first transmission 141 is not limited by the present disclosure. In one embodiment, the first transmission 141 may be a ratchet. For illustrative purposes, FIGS. 1-2 show that the first transmission 141 may be a gear. In another embodiment, the first transmission 141 may also be any appropriate auxiliary body that capable of transmitting the rotational movement. Further, the second transmission 142, the third transmission 143, the fourth transmission 144, the fifth transmission 145, the sixth transmission 146, and the seventh transmission 147 each may be similar to the first transmission 141, and the details will not be described herein. For illustrative purposes, FIGS. 1-2 show the first transmission 141, the second transmission 142, the third transmission 143, the fourth transmission 144, the fifth transmission 145, the sixth transmission 146 and the seventh transmission 147 each may be a gear. In one embodiment, the first transmission 141, the second transmission 142, the third transmission 143, the fourth transmission 144, the fifth transmission 145, the sixth the transmission 146, and the seventh transmission 147 may be gears having the same modulus and the same number of teeth, thereby simplifying the manufacturing process.

The number of the first rotating shafts in the first rotating shaft assembly 152 may be determined according to various application scenarios. As the number of the first rotating shafts in the first rotating shaft assembly 152 increases, the first distance may gradually increase, and after the connecting device and the bent portion 133 are unfolded, the area of the connecting device for absorbing the wrinkles of the bent portion 133 may also increase. To ensure that the rotating direction of the third transmission 143 is opposite to the rotating direction of the fourth transmission 144, the number of the first rotating shafts in the first rotating shaft assembly 152 may be an even number. That is, the opposite rotating of the third transmission 143 and the fourth transmission 144 may be enabled by an even number of auxiliary bodies that transmit rotational movement.

For illustrative purposes, FIGS. 1-2 show that the first rotating shaft assembly 152 may include two first rotating shafts. The first rotating shaft that abuts the first fixed shaft 151 may have at least one end provided with the third transmission 143 which is rotatable, and the third transmission 143 may be cooperatively coupled to the second transmission 142. The first rotating shaft that abuts the second rotating shaft 155 may have at least one end provided with the fourth transmission 144 which is rotatable, and the fourth transmission 144 may be cooperatively coupled to the third transmission 143.

The third transmission 143 may be disposed at both ends of the first rotating shaft that abuts the first fixed shaft 151, or may be disposed at one end of the first rotating shaft that abuts the first fixed shaft 151. The fourth transmission 144 may be disposed at both ends of the first rotating shaft that abuts the second rotating shaft 155, or may be disposed at one end of the first rotating shaft that abuts the second rotating shaft 155.

The present disclosure does not limit the structure of the connector 153, as long as the connector 153 is hinged to the second fixed shaft 154 and fixedly coupled to the second rotating shaft 155. For illustrative purposes, FIGS. 2-3 show that the connector 153 may have one end hinged with the second fixed shaft 154 and another end fixedly coupled to the second rotating shaft 155.

In one embodiment, the first transmission 141, the second transmission 142, the third transmission 143, the fourth transmission 144, the fifth transmission 145, the sixth transmission 146 and the seventh transmission 147 each may be a gear. To prevent the respective transmission from being disengaged, the connecting device may further include a fixed structure for fixing the shaft of the respective transmission. For illustrative purposes, FIG. 3 shows that the first transmission 141 may be fixedly coupled to the first body 110 through a third fixed shaft 156, and the seventh transmission 147 may be fixedly coupled to the second body 120 through a fourth fixed shaft 157. To prevent the first transmission 141 and the second transmission 142 from being disengaged, the connecting device may further include a first fastener 161 which fastens the third fixed shaft 156 and the first fixed shaft 151. To prevent the second transmission 142 and the third transmission 143 from being disengaged and the third transmission 143 and the fourth transmission 144 from being disengaged, the connecting device may further include a second fastener 162 which fastens the first rotating shaft assembly 152 and the first fixed shaft 151 and fastens the adjacent first rotating shafts in the first rotating shaft assembly 152.

To prevent the fourth transmission 144 and the fifth transmission 145 from being disengaged, the connecting device further may include a third fastener 163 that fastens the second rotating shaft 155 and one first rotating shaft that abuts the second rotating shaft 155. To prevent the sixth transmission 146 and seventh transmission 147 from being disengaged, the connecting device may further include a fourth fastener 164 that fastens the fourth fixed shaft 157 and the second fixed shaft 154.

Further, each fastener may be provided with a through hole having a pre-determined distance, and the distance between the shafts may be constant by inserting the shafts into respective through holes, thereby preventing the transmissions from being disengaged. The pre-determined distance may be a distance between the transmissions fixed to two shafts, where the transmissions fixed to the two shafts are cooperatively coupled to each other. To prevent the respective transmissions from interfering in the folded state, certain transmissions may be displaced in the axial direction. For illustrative purposes, FIG. 3 shows that the first transmission 141 and the third transmission 143 are displaced in the axial direction.

The first transmission 141 to the seventh transmission 147 may be configured to be in the straightened state according to various application scenarios. The straightened state of the first transmission 141 to the seventh transmission 147 and the folded state of the first transmission 141 to the seventh transmission 147 are relatively speaking, as long as the first distance is larger than the second distance, in which the first distance is a distance between the first body 110 and the second body 120 when the first transmission 141 to the seventh transmission 147 are in the straightened state, and the second distance is a distance between the first body 110 and the second body 120 when the first transmission 141 to the seventh transmission 147 are in the folded state.

In one embodiment, when the axis of the first transmission 141, the axis of the second transmission 142, the axis of the third transmission 143, the axis of the fourth transmission 144, the axis of the fifth transmission 145, the axis of the sixth transmission 146, and the axis of the seventh transmission 147 are in a same plane, the first transmission 141 to the seventh transmission 147 may be in the straightened state. In another embodiment, when the axis of the first transmission 141, the axis of the second transmission 142, the axis of the third transmission 143, the axis of the fourth transmission 144, the axis of the fifth transmission 145, the axis of the sixth transmission 146, and the axis of the seventh transmission 147 are not in a same plane, the first transmission 141 to the seventh transmission 147 may be in the straightened state.

For illustrative purposes, FIGS. 1-2 show that the axes of the first transmission 141 and the second transmission 142 are in the same plane; the axes of the second transmission 142, the third transmission and the fourth transmission 144 are in the same plane; the axes of the fifth transmission 145 and the sixth transmission 146 are in the same plane; and the axes of the sixth transmission 146 and the seventh transmission 147 are in the same plane. Accordingly, the first transmission 141to the seventh transmission 147 may be all in the folded state. Through configuring the angle between a first plane and a second plane to have different values, the folding degree may vary, in which the axes of the second transmission 142, the third transmission 143, and the fourth transmission 144 are located in the first plane, and the axes of the fifth transmission 145 and the sixth transmission 146 are located in the second plane.

Further, the electronic device may include a first positioning mechanism and a second positioning mechanism, when the first transmission 141 to the seventh transmission 147 are in the straightened state, the first positioning mechanism may be clamped between the first transmission 141 and the second transmission 142, and the second positioning mechanism may be clamped between the sixth transmission 146 and the seventh transmission 147, for ensuring that the first transmission 141 to the seventh transmission 147 are stably in the straightened state. For illustrative purposes, FIG. 1 shows that the first transmission 141 to the seventh transmission 147 may be in the folded state, the first body 110 and the second body 120 may be fitted to ensure the first transmission 141 to the seventh transmission 147 are stably in the folded state. Other fixed structures may also be configured to enable the connecting device to be in a stable state.

In the disclosed embodiments, the electronic device may include a main body and an auxiliary body. The main body of the electronic device may be transformed under an external force, and during the transformation of the main body of the electronic device, the auxiliary body of the electronic device may be transformed along with the main body. The transformation direction of the main body may be opposite to the transformation direction of the auxiliary body. Through configuring the main body of the electric device to be transformed under the external force, more flexible applications of the electric device may be allowed.

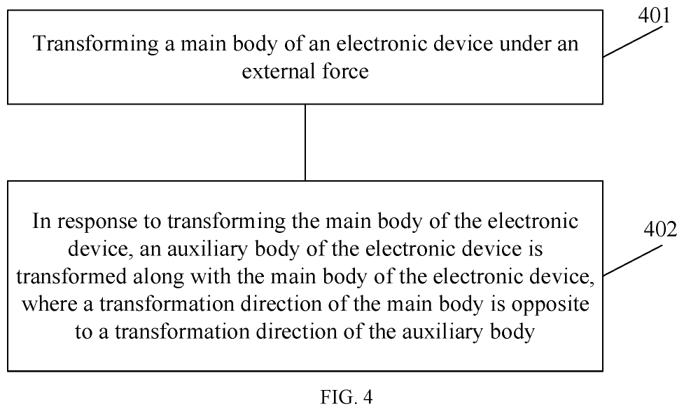

The present disclosure further provides an electronic device transforming method. FIG. 4 illustrates a flow chart of an exemplary electronic device transforming method consistent with the disclosed embodiments. The embodiment of the transforming method of the electronic device corresponds to the embodiment of the electronic device shown in FIGS. 1-3 and, therefore, the operations and features described in the embodiments of the electronic device shown in FIGS. 1 and 3 are also applicable to embodiments of the transforming method of the electronic device, and the detailed description thereof is omitted herein.

As shown in FIG. 4, the electronic device transforming method may include:

Step 401: transforming the main body of the electronic device under an external force.

Step 402: in response to transforming the main body of the electronic device, the auxiliary body of the electronic device is transformed along with the transformation of the main body of the electronic device, where the transformation direction of the main body is opposite to the transformation direction of the auxiliary body.

Here, the electronic device, the main body and the auxiliary body of the electronic device have been described in the embodiments of the electronic device, and details are not described herein again.

In the disclosed embodiments, the main body of the electronic device may include a first body, a second body and a flexible screen. The auxiliary body of the electronic device may include a connecting device. The first body may be rotatably coupled to the second body through the connecting device. The flexible screen may be fixedly disposed on the first body and the second body. The transforming method may further comprise: under the external force, rotating the first body relative to the second body within a predetermined range, with respect to an axis between the first body and the second body, to transform the flexible screen. In response to transforming the flexible screen, the connecting device may be transformed along with the flexible screen, and the transformation direction of the connecting device may be opposite to the transformation direction of the flexible screen.

The first body, the second body, the predetermined range, the flexible screen, and the connecting device have been described in the embodiments of the electronic device, and details are not described herein again.

In one embodiment, the flexible screen may include a first planar portion, a second planar portion and a bent portion. The first planar portion may be disposed on an outer side surface of the first body, where the outer side surface of the first body rotates relative to the second body. The second planar portion may be disposed on an outer side surface of the second body, where the outer side surface of the second body rotates relative to the first body. The bent portion may couple the first planar portion to the second planar portion, and the bent portion may be abutted against the connecting device.

The electronic device transforming method may comprise: under the external force, rotating the first body relative to the second body via the connecting device under the external force, wherein along with the first body, the first planar portion may be rotated relative to the second planar portion via the bent portion, to transform the bent portion. In response to transforming the bent portion, the connecting device may be transformed along with the bent portion, and the transformation direction of the connecting device may be opposite to the transformation direction of the bent portion.

The first planar portion and the second planar portion have been described in the above embodiments of the electronic device, the details are not described herein again.

The present disclosure does not limit the specific states of the transformation process of the connecting device and the bent portion, and those skilled in the art may determine the specific states of the transformation process of the connecting device and the bent portion according to various application scenarios.

In one embodiment, the transformation method may include the following steps.

Under an external force, rotating the first body relative to the second body in a first direction through the connecting device. The first body may be rotated relative to the second body to the first angle. In response to rotating the first body relative to the second body to a first angle, the connecting device may be in a straightened state, the first body and the second body may be apart from each other by a first distance, the first planar portion may be rotated relative to the second planar portion to a third angle along with the first body, and the connecting device in the straightened state may support the bent portion to enable the bent portion to be in an unfolded state. The first body may be rotated relative to the second body to a second angle. In response to rotating the first body relative to the second body to the second angle from the first angle, the connecting device may be gradually folded in a direction far away from the bent portion, the first body may be moved relative to the second body in a direction close to the second body, the distance between the first body and the second body may gradually decrease to a second distance, and the connecting device may be in a folded state. The first planar portion may be rotated relative to the second planar portion to a fourth angle from the third angle along with the first body, the bent portion may be gradually bent in a direction away from the connecting device, and the connecting device in a folded state may support the bent portion to enable the bent portion to be in a bent state.

Under an external force, rotating the first body relative to the second body through the connecting device in the second direction. The first body may be rotated relative to the second body to the second angle. In response to rotating the first body relative to the second body to the second angle, the connecting device may be in the folded state, the first body and the second body may be apart from each other by a second distance, the first planar portion may be rotated relative to the second planar portion to the fourth angle along with the first body, and the connecting device in the folded state may support the bent portion to enable the bent portion to be in the bent state. The first body may be rotated relative to the second body to the first angle from the second angle. In response to rotating the first body relative to the second body to the first angle from the second angle, the connecting device may be gradually unfolded in a direction close to the bent portion, the first body may be moved relative to the second body in a direction away from the second body, the distance between the first body and the second body may gradually increase to the first distance, and the connecting device may be in the straightened state. The first planar portion may be rotated relative to the second planar portion from the fourth angle to the third angle, the bent portion may be gradually unfolded in a direction close to the connecting device, and the connecting device in the straightened state may support the bent portion to enable the bent portion to be in the unfolded state. The first direction may be opposite to the second direction are opposite.

In the disclosed embodiments, through configuring the connecting device to be in the straightened state, the connecting device may support the bent portion to enable the bent portion to be in the unfolded state, which may effectively prevent wrinkles on the bent portion. On the other hand, through configuring the connecting device to be in the folded state, the connecting device may support the bent portion to enable the bent portion to be in the folded state, which may effectively prevent the bent portion from being damaged by the connecting device when the bent portion is being bent.

The straightened state, the folded state, the unfolded state, the bent state, the first angle, the first distance, the third angle, the second angle, the second distance, the fourth angle, the first direction and the second direction have been described in the above embodiments of the electronic device, and the details are not described herein again.

The specific states of the transformation process of the connecting device and the specific states of the transformation process of the bent portion will be described in detail below based on an exemplary connecting device.

In one embodiment, the connecting device may include a first transmission, a second transmission, a third transmission, a fourth transmission, a fifth transmission, a sixth transmission, a seventh transmission, a first fixed shaft, a first rotating shaft assembly, a connector, a second fixed shaft, and a second rotating shaft.

In particular, the first transmission may be fixedly coupled to the first body. The first fixed shaft may be provided with the second transmission which is a rotatable. The second transmission may be cooperatively coupled to or mating connected to the first transmission. The first rotating shaft assembly may include at least two first rotating shafts. The at least two first rotating shafts may include one first rotating shaft that abuts the first fixed shaft and another first rotating shaft that abuts the second rotating shaft. The first rotating shaft that abuts the first fixed shaft may have at least one end provided with the third transmission which is rotatable, the third transmission may be cooperatively coupled to the second transmission. The first rotating shaft that abuts the second rotating shaft may have at least one end provided with the fourth transmission which is rotatable, and the fourth transmission may be cooperatively coupled to the third transmission.

The seventh transmission may be fixedly coupled to the second body. The second fixed shaft may be fixedly disposed with the sixth transmission, and the sixth transmission may be cooperatively coupled to the seventh transmission. The connector may be hinged to the second fixed shaft. The second rotating shaft may be fixedly coupled to the connector, and may be fixedly disposed with the fifth transmission. The fifth transmission may be cooperatively coupled to the fourth transmission.

In one embodiment, the transformation method may include the following steps.

Under the external force, rotating the first body relative to the second body in the first direction through the first transmission, the second transmission, the third transmission, the fourth transmission, the fifth transmission, the sixth transmission and the seventh transmission. The first body may be rotated relative to the second body to the first angle. In response to rotating the first body relative to the second body to the first angle, the first transmission to the seventh transmission may be in the straightened state, the first body and the second body may be apart by the first distance, the first planar portion may be rotated relative to the second planar portion to the third angle along with the first body, and the first transmission to the seventh transmission in the straightened state may support the bent portion to enable the bent portion to be in the unfolded state.

The first body may be rotated relative to the second body to the second angle from the first angle. In response to rotating the first body relative to the second body to the second angle from the first angle, the first transmission may be rotated in the first direction along with the first body and gradually moved in a direction away from the bent portion, the second transmission may be rotated in the second direction along with the first transmission, the third transmission may be rotated in the first direction along with the second transmission, the fourth transmission may be rotated in the second direction along with the third transmission, the fifth transmission may be rotated in the first direction along with the fourth transmission and rotated around the second rotating shaft through the connector, the fifth transmission and the fourth transmission may be gradually moved in a direction away from the bent portion, the third transmission may gradually move in a direction away from the bent portion along with the fourth transmission, the seventh transmission may be rotated along the second direction along with the second body and gradually moved in a direction far away from the bent portion, the first body may be moved relative to the second body in a direction close to the second body, the distance between the first body and the second body may be gradually reduced to the second distance, the first transmission to the seventh transmission may be in the folded state, the bent portion may be gradually bent in a direction away from the second transmission, and the second transmission and the sixth transmission in the folded state may support the bent portion to enable the bent portion to be in the bent state.

Under the external force, rotating the first body relative to the second body in the second direction through the first transmission, the second transmission, the third transmission, the fourth transmission, the fifth transmission, the sixth transmission, and the seventh transmission. The first body may be rotated relative to the second body to the second angle. In response to rotating the first body relative to the second body to the second angle, the first transmission to the seventh transmission may be in the folded state, the first body and the second body may be apart by the second distance, the first planar portion may rotated relative to the second planar portion to the fourth angle along with the first body, and the second transmission and the sixth transmission in the folded state may support the bent portion to enable the bent portion to be in the bent state. In response to rotating the first body relative to the second body from the second angle to the first angle, the first transmission may be rotated in the second direction along with the first body, the first transmission may be gradually moved in a direction close to the bent portion, the second transmission may be rotated in the first direction along with the first transmission, the third transmission may be rotated in the second direction along with the second transmission, the fourth transmission may be rotated in the first direction along with the third transmission, the fifth transmission may be rotated in the second direction along with the fourth transmission and rotated around the second rotating shaft through the connector, the fifth transmission and the fourth transmission may be gradually moved in a direction close to the bent portion, the third transmission may be gradually moved in a direction close to the bent portion along with the fourth transmission, the seventh transmission may be rotated along the first direction along with the second body and gradually moved in a direction close to the bent portion, the first body may be moved relative to the second body in a direction far away from the second body, the distance between the first body and the second body may be gradually increased to the first distance, the first transmission to the seventh transmission may be in the straightened state, the first planar portion may be rotated relative to the second planar portion from the fourth angle to the third angle along with the first body, the bent portion may be gradually unfolded in a direction close to the second transmission, and the first transmission to the seventh transmission in the straightened state may support the bent portion to enable the bent portion to be in the unfolded state.

The first transmission, the second transmission, the third transmission, the fourth transmission, the fifth transmission, the sixth transmission and the seventh transmission, the first fixed shaft, the second fixed shaft, the first rotating shaft assembly, the connector, the straightened state and the folded state all have been described in the above embodiments of the electronic device, and the details are not described herein again.

In the disclosed embodiments, the electronic device may include a main body and an auxiliary body. The main body of the electronic device may be transformed under an external force, and during the transformation of the main body of the electronic device, the auxiliary body of the electronic device may be transformed along with the main body. The transformation direction of the main body may be opposite to the transformation direction of the auxiliary body. Through configuring the main body of the electric device to be transformed under the external force, more flexible applications of the electric device may be allowed.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An electronic device transforming method, comprising:
transforming a main body of an electronic device under an external force,
wherein in response to transforming the main body of the electronic device, an auxiliary body of the electronic device is transformed along with the main body of the electronic device, and a transformation direction of the main body is opposite to a transformation direction of the auxiliary body.

2. The electronic device transforming method according to claim 1, wherein the main body of the electronic device includes a first body, a second body, and a flexible screen; the auxiliary body of the electronic device includes a connecting device, wherein the first body is rotatably coupled to the second body through the connecting device, and the flexible screen is fixedly disposed on the first body and the second body, the electronic device transforming method further comprises:
under the external force, rotating the first body relative to the second body within a predetermined range, with respect to an axis between the first body and the second body, to transform the flexible screen,
wherein in response to transforming the flexible screen, the connecting device is transformed along with the flexible screen, and a transformation direction of the connecting device is opposite to a transformation direction of the flexible screen.

3. The electronic device transforming method according to claim 2, wherein the flexible screen includes a first planar portion disposed on an outer side surface of the first body where the outer side surface of the first body rotates relative to the second body, a second planar portion disposed on an outer side surface of the second body where the outer side surface of the second body rotates relative to the first body, and a bent portion coupling the first planar portion to the second planar portion and abutted against the connecting device, the electronic device transforming method further comprise:
rotating the first body relative to the second body via the connecting device under the external force,
wherein along with the first body, the first planar portion is rotated relative to the second planar portion via the bent portion, to transform the bent portion,
in response to transforming the bent portion, the connecting device is transformed along with the bent portion, and
the transformation direction of the connecting device is opposite to a transformation direction of the bent portion.

4. The electronic device transforming method according to claim 3, further comprising:
under the external force, rotating the first body relative to the second body in a first direction via the connecting device,
wherein in response to rotating the first body relative to the second body to a first angle, the connecting device is in a straightened state, the first body and the second body is apart from each other by a first distance, the first planar portion is rotated relative to the second planar portion to a third angle along with the first body, the connecting device in the straightened state supports the bent portion to enable the bent portion to be in an unfolded state, and
wherein in response to rotating the first body relative to the second body to a second angle from the first angle, the connecting device is gradually folded in a direction far away from the bent portion, the first body is moved relative to the second body in a direction close to the second body, the distance between the first body and the second body gradually decreases to a second distance, the connecting device is in a folded state, the first planar portion is rotated relative to the second planar portion to a fourth angle from the third angle along with the first body, the bent portion is gradually bent in a direction away from the connecting device, and the connecting device in a folded state supports the bent portion to enable the bent portion to be in a bent state; and
under the external force, rotating the first body relative to the second body in the second direction via the connecting device,
wherein in response to rotating the first body relative to the second body to a second angle, the connecting device is in the folded state, the first body and the second body is apart from each other by a second distance, the first planar portion is rotated relative to the second planar portion to the fourth angle along with the first body, the connecting device in the folded state supports the bent portion to enable the bent portion to be in the bent state, and
wherein in response to rotating the first body relative to the second body from the second angle to the first angle, the connecting device is gradually unfolded in a direction close to the bent portion, the first body is moved relative to the second body in a direction away from the second body, the distance between the first body and the second body gradually increases to the first distance, the connecting device is in the straightened state, the first planar portion is rotated relative to the second planar portion from the fourth angle to the third angle, the bent portion is gradually unfolded in a direction close to the connecting device, and the connecting device in the straightened state supports the bent portion to enable the bent portion to be in the unfolded state,
wherein the first direction is opposite to the second direction.

5. The electronic device transforming method according to claim 4, wherein the connecting device includes a first transmission, a second transmission, a third transmission, a fourth transmission, a fifth transmission, a sixth transmission, a seventh transmission, a first fixed shaft, a first rotating shaft assembly, a connector, a second fixed shaft, and a second rotating shaft, wherein the first transmission is fixedly coupled to the first body, the first fixed shaft is provided with the second transmission which is a rotatable, wherein the second transmission is cooperatively coupled to the first transmission, wherein the first rotating shaft assembly includes at least two first rotating shafts, wherein the at least two first rotating shafts includes one first rotating shaft that abuts the first fixed shaft and one first rotating shaft that abuts the second rotating shaft, wherein the first rotating shaft that abuts the first fixed shaft has at least one end provided with the third transmission which is rotatable, and the third transmission is cooperatively coupled to the second transmission, wherein the first rotating shaft that abuts the second rotating shaft has at least one end provided with the fourth transmission which is rotatable, and the fourth transmission is cooperatively coupled to the third transmission, wherein the seventh transmission is fixedly coupled to the second body, wherein the second fixed shaft is fixedly disposed with the sixth transmission, and the sixth transmission is cooperatively coupled to the seventh transmission, wherein the connector is hinged to the second fixed shaft, and the second rotating shaft is fixedly coupled to the connector and is fixedly disposed with the fifth transmission, wherein the fifth transmission is cooperatively coupled to the fourth transmission, the electronic device transforming method further comprise:
under the external force, rotating the first body relative to the second body in the first direction through the first transmission, the second transmission, the third transmission, the fourth transmission, the fifth transmission, the sixth transmission and the seventh transmission,
wherein in response to rotating the first body relative to the second body to the first angle, the first transmission to the seventh transmission are in the straightened state, the first body and the second body is apart by the first distance, the first planar portion is rotated relative to the second planar portion to the third angle along with the first body, the first transmission to the seventh transmission in the straightened state support the bent portion to enable the bent portion to be in the unfolded state, and
wherein in response to rotating the first body relative to the second body from the first angle to the second angle, the first transmission is rotated in the first direction along with the first body and is gradually moved in a direction away from the bent portion, the second transmission is rotated in the second direction along with the first transmission, the third transmission is rotated in the first direction along with the second transmission, the fourth transmission is rotated in the second direction along with the third transmission, the fifth transmission is rotated in the first direction along with the fourth transmission and rotated around the second rotating shaft through the connector, the fifth transmission and the fourth transmission are gradually moved in a direction away from the bent portion, the third transmission is gradually moved in a direction away from the bent portion along with the fourth transmission, the seventh transmission is rotated along the second direction along with the second body and gradually moved in a direction far away from the bent portion, the first body is moved relative to the second body in the direction close to the second body, the distance between the first body and the second body is gradually reduced to the second distance, the first transmission to the seventh transmission are in the folded state, the bent portion is gradually bent in a direction away from the second transmission, and the second transmission and the sixth transmission in the folded state support the bent portion to enable the bent portion to be in the bent state; and
under the external force, rotating the first body relative to the second body in the second direction through the first transmission, the second transmission, the third transmission, the fourth transmission, the fifth transmission, the sixth transmission, and the seventh transmission,
wherein in response to rotating the first body relative to the second body to the second angle, the first transmission to the seventh transmission are in the folded state, the first body and the second body is apart by the second distance, the first planar portion is rotated relative to the second planar portion to the fourth angle along with the first body, the second transmission and the sixth transmission in the folded state support the bent portion to enable the bent portion to be in the bent state, and
wherein in response to rotating the first body relative to the second body from the second angle to the first angle, the first transmission is rotated in the second direction along with the first body, the first transmission is gradually moved in the direction close to the bent portion, the second transmission is rotated in the first direction along with the first transmission, the third transmission is rotated in the second direction along with the second transmission, the fourth transmission is rotated in the first direction along with the third transmission, the fifth transmission is rotated in the second direction along with the fourth transmission and rotated around the second rotating shaft through the connector, the fifth transmission and the fourth transmission are gradually moved in the direction close to the bent portion, the third transmission is gradually moved in the direction close to the bent portion along with the fourth transmission, the seventh transmission is rotated along the first direction along with the second body and gradually moved in the direction close to the bent portion, the first body is moved relative to the second body in a direction far away from the second body, the distance between the first body and the second body is gradually increased to the first distance, the first transmission to the seventh transmission are in the straightened state, the first planar portion is rotated relative to the second planar portion from the fourth angle to the third angle along with the first body, the bent portion is gradually unfolded in a direction close to the second transmission, and the first transmission to the seventh transmission in the straightened state support the bent portion to enable the bent portion to be in the unfolded state.

6. An electronic device, comprising:
a main body, wherein the main body is transformed under an external force; and
an auxiliary body, wherein in response to transforming the main body of the electronic device, the auxiliary body is transformed along with the main body, and a transformation direction of the main body is opposite to a transformation direction of the auxiliary body.

7. The electronic device according to claim 6, wherein:
the main body includes a first body, a second body, and a flexible screen; and
the auxiliary body includes a connecting device,
wherein the first body is rotatably coupled to the second body through the connecting device,
the flexible screen is fixedly disposed on the first body and the second body,
under the external force, the first body is rotated relative to the second body within a predetermined range, with respect to an axis between the first body and the second body, to transform the flexible screen,
in response to transforming the flexible screen, the connecting device is transformed along with the flexible screen, and
a transformation direction of the connecting device is opposite to a transformation direction of the flexible screen.

8. The electronic device according to claim 7, wherein:
the flexible screen includes a first planar portion disposed on an outer side surface of the first body where the outer side surface of the first body rotates relative to the second body, a second planar portion disposed on an outer side surface of the second body where the outer side surface of the second body rotates relative to the first body, and a bent portion coupling the first planar portion to the second planar portion and abutted against the connecting device,
wherein under the external force, the first body is rotated relative to the second body via the connecting device,
along with the first body, the first planar portion is rotated relative to the second planar portion via the bent portion, to transform the bent portion, and
in response to transforming the bent portion, the connecting device is transformed along with the bent portion, and the transformation direction of the connecting device is opposite to a transformation direction of the bent portion.

9. The electronic device according to claim 8, wherein:
under the external force, the first body is rotated relative to the second body in a first direction via the connecting device,
wherein in response to rotating the first body relative to the second body to a first angle, the connecting device is in a straightened state, the first body and the second body is apart from each other by a first distance, the first planar portion is rotated relative to the second planar portion to a third angle along with the first body, the connecting device in the straightened state supports the bent portion to enable the bent portion to be in an unfolded state, and
wherein in response to rotating the first body relative to the second body to a second angle from the first angle, the connecting device is gradually folded in a direction far away from the bent portion, the first body is moved relative to the second body in a direction close to the second body, the distance between the first body and the second body gradually decreases to a second distance, the connecting device is in a folded state, the first planar portion is rotated relative to the second planar portion to a fourth angle from the third angle along with the first body, the bent portion is gradually bent in a direction away from the connecting device, and the connecting device in a folded state supports the bent portion to enable the bent portion to be in a bent state; and
under the external force, the first body is rotated relative to the second body in the second direction via the connecting device,
wherein in response to rotating the first body relative to the second body to a second angle, the connecting device is in the folded state, the first body and the second body is apart from each other by a second distance, the first planar portion is rotated relative to the second planar portion to the fourth angle along with the first body, the connecting device in the folded state supports the bent portion to enable the bent portion to be in the bent state, and
wherein in response to rotating the first body relative to the second body from the second angle to the first angle, the connecting device is gradually unfolded in a direction close to the bent portion, the first body is moved relative to the second body in a direction away from the second body, the distance between the first body and the second body gradually increases to the first distance, the connecting device is in the straightened state, the first planar portion is rotated relative to the second planar portion from the fourth angle to the third angle, the bent portion is gradually unfolded in a direction close to the connecting device, and the connecting device in the straightened state supports the bent portion to enable the bent portion to be in the unfolded state,
wherein the first direction is opposite to the second direction.

10. The electronic device according to claim 9, wherein:
the connecting device includes a first transmission, a second transmission, a third transmission, a fourth transmission, a fifth transmission, a sixth transmission, a seventh transmission, a first fixed shaft, a first rotating shaft assembly, a connector, a second fixed shaft, and a second rotating shaft,
wherein the first transmission is fixedly coupled to the first body, the first fixed shaft is provided with the second transmission which is a rotatable,
wherein the second transmission is cooperatively coupled to the first transmission,
wherein the first rotating shaft assembly includes at least two first rotating shafts,
wherein the at least two first rotating shafts include one first rotating shaft that abuts the first fixed shaft and one first rotating shaft that abuts the second rotating shaft,
wherein the first rotating shaft that abuts the first fixed shaft has at least one end provided with the third transmission which is rotatable, and the third transmission is cooperatively coupled to the second transmission,
wherein the first rotating shaft that abuts the second rotating shaft has at least one end provided with the fourth transmission which is rotatable, and the fourth transmission is cooperatively coupled to the third transmission,
wherein the seventh transmission is fixedly coupled to the second body,
wherein the second fixed shaft is fixedly disposed with the sixth transmission, and the sixth transmission is cooperatively coupled to the seventh transmission,
wherein the connector is hinged to the second fixed shaft, and the second rotating shaft is fixedly coupled to the connector, and is fixedly disposed with the fifth transmission,
wherein the fifth transmission is cooperatively coupled to the fourth transmission,
wherein under the external force, the first body is rotated relative to the second body in the first direction through the first transmission, the second transmission, the third transmission, the fourth transmission, the fifth transmission, the sixth transmission and the seventh transmission,
wherein in response to rotating the first body relative to the second body to the first angle, the first transmission to the seventh transmission are in the straightened state, the first body and the second body is apart by the first distance, the first planar portion is rotated relative to the second planar portion to the third angle along with the first body, the first transmission to the seventh transmission in the straightened state support the bent portion to enable the bent portion to be in the unfolded state, and
wherein in response to rotating the first body relative to the second body from the first angle to the second angle, the first transmission is rotated in the first direction along with the first body and is gradually moved in a direction away from the bent portion, the second transmission is rotated in the second direction along with the first transmission, the third transmission is rotated in the first direction along with the second transmission, the fourth transmission is rotated in the second direction along with the third transmission, the fifth transmission is rotated in the first direction along with the fourth transmission and rotated around the second rotating shaft through the connector, the fifth transmission and the fourth transmission are gradually moved in a direction away from the bent portion, the third transmission is gradually moved in a direction away from the bent portion along with the fourth transmission, the seventh transmission is rotated along the second direction along with the second body and gradually moved in a direction far away from the bent portion, the first body is moved relative to the second body in the direction close to the second body, the distance between the first body and the second body is gradually reduced to the second distance, the first transmission to the seventh transmission are in the folded state, the bent portion is gradually bent in a direction away from the second transmission, and the second transmission and the sixth transmission in the folded state support the bent portion to enable the bent portion to be in the bent state; and
wherein under the external force, the first body is rotated relative to the second body in the second direction through the first transmission, the second transmission, the third transmission, the fourth transmission, the fifth transmission, the sixth transmission, and the seventh transmission,
wherein in response to rotating the first body relative to the second body to the second angle, the first transmission to the seventh transmission are in the folded state, the first body and the second body is apart by the second distance, the first planar portion is rotated relative to the second planar portion to the fourth angle along with the first body, the second transmission and the sixth transmission in the folded state support the bent portion to enable the bent portion to be in the bent state, and
wherein in response to rotating the first body relative to the second body from the second angle to the first angle, the first transmission is rotated in the second direction along with the first body, the first transmission is gradually moved in the direction close to the bent portion, the second transmission is rotated in the first direction along with the first transmission, the third transmission is rotated in the second direction along with the second transmission, the fourth transmission is rotated in the first direction along with the third transmission, the fifth transmission is rotated in the second direction along with the fourth transmission and rotated around the second rotating shaft through the connector, the fifth transmission and the fourth transmission are gradually moved in the direction close to the bent portion, the third transmission is gradually moved in the direction close to the bent portion along with the fourth transmission, the seventh transmission is rotated along the first direction along with the second body and gradually moved in the direction close to the bent portion, the first body is moved relative to the second body in a direction far away from the second body, the distance between the first body and the second body is gradually increased to the first distance, the first transmission to the seventh transmission are in the straightened state, the first planar portion is rotated relative to the second planar portion from the fourth angle to the third angle along with the first body, the bent portion is gradually unfolded in a direction close to the second transmission, and the first transmission to the seventh transmission in the straightened state support the bent portion to enable the bent portion to be in the unfolded state.
